(19) United States
(12) Patent Application Publication
(10) Pub. No.: US 2026/0046686 A1
(43) Pub. Date: Feb. 12, 2026

(54) APPARATUS, METHODS, AND COMPUTER PROGRAMS

(71) Applicant: Nokia Technologies Oy, Espoo (FI)

(72) Inventors: Lazaros GKATZIKIS, Athens (GR); Janne Einari TUONONEN, Espoo (FI); Ville Petteri PÖYHÖNEN, Espoo (FI); Rainer LIEBHART, Munich (DE); Georgios GKELLAS, Athens (GR)

(21) Appl. No.: 19/101,771

(22) PCT Filed: Aug. 9, 2023
(86) PCT No.: PCT/IB2023/058053

§ 371 Date: Feb. 6, 2025

(30) Foreign Application Priority Data
Aug. 10, 2022 (GB) 2211695.8

(51) Int. Cl. H04W 28/02; H04W 24/08; H04W 28/082

(52) U.S. Cl. CPC H04W 28/0284; H04W 24/08; H04W 28/082

(57) ABSTRACT

An apparatus comprising means for determining, that data duplication over a plurality of respective paths between one or more communication devices and a network entity is to be modified to reduce or suspend the data duplication.

### RELATED APPLICATIONS

This patent application claims the benefit of priority of United Kingdom Patent Application No 2211695.8, filed Aug. 10, 2022, the contents of which are hereby incorporated by reference as if reproduced in their entirety.

### FIELD OF THE DISCLOSURE

The present disclosure relates to apparatus, methods, and computer programs and in particular but not exclusively to apparatus, methods and computer programs for use in networks which use a plurality of communication paths.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of a standard are the so-called 5G standards.

### SUMMARY

According to a first aspect, there is provided an apparatus comprising: means for determining, that data duplication over a plurality of respective paths between one or more communication devices and a network entity is to be modified to reduce or suspend the data duplication.

The means for determining that the data duplication is to be reduced or suspended, may determine one or more of: for which of the one or communication devices the data duplication is to be reduced or suspended; on which path for a respective communication device the data duplication is to be reduced or suspended; and/or for a respective communication device by how much the data duplication is to be reduced.

The means for determining that the data duplication is to be reduced or suspended, may determine for which of the one or communication devices the data duplication is to be reduced or suspended.

The means for determining that the data duplication is to be reduced or suspended, may determine on which path for a respective communication devices the data duplication is to be reduced or suspended.

The means for determining that the data duplication is to be reduced or suspended, may determine for a respective communication device by how much the data duplication is to be reduced.

The means for determining that the data duplication is to be reduced or suspended, may determine that the data duplication is to be reduced or suspended in response to network congestion.

The apparatus may comprise means for determining network congestion.

The apparatus may comprise means for determining network congestion based on information from one or more communication devices, and/or one or more network entities.

The apparatus may comprise means for determining network congestion based on information received by a network entity via control plane or user plane connections.

The apparatus may comprise means for determining an indication of a usefulness of the duplication.

The indication of the usefulness of the duplication may be based on a number of data duplicates which had not previously been successfully received over another path.

The indication of the usefulness of the duplication may be used to determine one or more of: network congestion; and/or that data duplication for a respective communication device is to be reduced or suspended.

The means for determining that the data duplication is to be reduced or suspended may use the indication of the usefulness of the duplication to determine network congestion.

The means for determining that the data duplication is to be reduced or suspended, may determine that the data duplication for a respective communication device is to be reduced or suspended based on the indication of the usefulness of the duplication.

The apparatus may comprise means for receiving rules with an indication that one of more of the one or more communication devices and/or the network entity can determine to reduce or suspend data duplication.

The rules may be received from a control plane entity.

The apparatus may comprise means for causing a message to be sent to a respective communication device indicating that data duplication between that communication device and the network entity is to be modified to reduce or suspend the data duplication.

The message may comprise one or more of: information indicating a quantity of the reduction of the data duplication; information as to a duration of the reducing or suspending of the data duplication; and/or information indicating on which of the plurality of paths the data duplication is to be reduced or suspended.

The message may be sent to the respective communication device via the user plane.

The message may comprise information indicating a quantity of the reduction of the data duplication.

The message may comprise information as to a duration of the reducing or suspending of the data duplication.

The message may comprise information indicating on which of the plurality of paths the data duplication is to be reduced or suspended.

The apparatus may comprise means for subsequently causing a message to be sent to a respective communication device ending the reducing or suspending the data duplication.

The apparatus may be provided in or by the network entity and said network entity may be a user plane function.

The apparatus may comprise means for receiving from a decision entity information used by the determining means to determine that data duplication between the communication device and the network entity is to be modified to reduce or suspend the data duplication.

The information from the decision making entity may comprise one or more of: network area information associated with data duplication; monitoring information for the monitoring of congestion in the network; and/or traffic duplication modification information.

The apparatus may comprise means for reporting network congestion information to the decision entity.

The apparatus may be provided in or by a decision entity.

According to a second aspect, there is provided an apparatus comprising: circuitry configured to determine, that data duplication over a plurality of respective paths between one or more communication devices and a network entity is to be modified to reduce or suspend the data duplication.

The circuitry configured to determine that the data duplication is to be reduced or suspended, may determine one or more of: for which of the one or communication devices the data duplication is to be reduced or suspended; on which path for a respective communication device the data duplication is to be reduced or suspended; and/or for a respective communication device by how much the data duplication is to be reduced.

The circuitry configured to determine that the data duplication is to be reduced or suspended, may determine for which of the one or communication devices the data duplication is to be reduced or suspended.

The circuitry configured to determine that the data duplication is to be reduced or suspended, may determine on which path for a respective communication devices the data duplication is to be reduced or suspended.

The circuitry configured to determine that the data duplication is to be reduced or suspended, may determine for a respective communication device by how much the data duplication is to be reduced.

The circuitry configured to determine that the data duplication is to be reduced or suspended, may determine that the data duplication is to be reduced or suspended in response to network congestion.

The apparatus may comprise circuitry configured to determine network congestion.

The apparatus may comprise circuitry configured to determine network congestion based on information from one or more communication devices, and/or one or more network entities.

The apparatus may comprise circuitry configured to determine network congestion based on information received by a network entity via control plane or user plane connections.

The apparatus may comprise circuitry configured to determine an indication of a usefulness of the duplication.

The indication of the usefulness of the duplication may be based on a number of data duplicates which had not previously been successfully received over another path.

The indication of the usefulness of the duplication may be used to determine one or more of: network congestion; and/or that data duplication for a respective communication device is to be reduced or suspended.

The circuitry configured to determine that the data duplication is to be reduced or suspended may use the indication of the usefulness of the duplication to determine network congestion.

The apparatus may comprise circuitry configured to receive rules with an indication that one of more of the one or more communication devices and/or the network entity can determine to reduce or suspend data duplication.

The circuitry configured to determine that the data duplication is to be reduced or suspended, may determine that the data duplication for a respective communication device is to be reduced or suspended based on received rules which have an indication that one of more of the one or more communication devices and/or the network entity can determine to reduce or suspend data duplication

The rules may be received from a control plane entity.

The apparatus may comprise circuitry configured to cause a message to be sent to a respective communication device indicating that data duplication between that communication device and the network entity is to be modified to reduce or suspend the data duplication.

The message may comprise one or more of: information indicating a quantity of the reduction of the data duplication; information as to a duration of the reducing or suspending of the data duplication; and/or information indicating on which of the plurality of paths the data duplication is to be reduced or suspended.

The message may be sent to the respective communication device via the user plane.

The message may comprise information indicating a quantity of the reduction of the data duplication.

The message may comprise information as to a duration of the reducing or suspending of the data duplication.

The message may comprise information indicating on which of the plurality of paths the data duplication is to be reduced or suspended.

The apparatus may comprise circuitry configured to subsequently cause a message to be sent to a respective communication device ending the reducing or suspending the data duplication.

The apparatus may be provided in or by the network entity, said network entity being a user plane function.

The apparatus may comprise circuitry configured to receive from a decision entity information used by the circuitry configured to determine that data duplication between the communication device and the network entity is to be modified to reduce or suspend the data duplication.

The information from the decision making entity may comprise one or more of: network area information associated with data duplication; monitoring information for the monitoring of congestion in the network; and/or traffic duplication modification information.

The apparatus may comprise circuitry configured to report network congestion information to the decision entity.

The apparatus may be provided in or by a decision entity.

According to a third aspect there is provided an apparatus comprising at least one processor and at least one memory storing instructions that, when executed by the at least one processor cause the apparatus at least to: determine, that data duplication over a plurality of respective paths between one or more communication devices and a network entity is to be modified to reduce or suspend the data duplication.

The apparatus may be caused to determine: for which of the one or communication devices the data duplication is to be reduced or suspended; on which path for a respective communication device the data duplication is to be reduced or suspended; and/or for a respective communication device by how much the data duplication is to be reduced.

The apparatus may be caused to determine for which of the one or communication devices the data duplication is to be reduced or suspended.

The apparatus may be caused to determine on which path for a respective communication devices the data duplication is to be reduced or suspended.

The apparatus may be caused to determine for a respective communication device by how much the data duplication is to be reduced.

The apparatus may be caused to determine that the data duplication is to be reduced or suspended in response to network congestion.

The apparatus may be caused to determine network congestion.

The apparatus may be caused to determine network congestion based on information from one or more communication devices, and/or one or more network entities.

The apparatus may be caused to determine network congestion based on information received by a network entity via control plane or user plane connections.

The apparatus may be caused to determine an indication of a usefulness of the duplication.

The indication of the usefulness of the duplication may be based on a number of data duplicates which had not previously been successfully received over another path.

The indication of the usefulness of the duplication may be used to determine one or more of: network congestion; and/or that data duplication for a respective communication device is to be reduced or suspended.

The apparatus may be caused to determine that the data duplication is to be reduced or suspended may use the indication of the usefulness of the duplication to determine network congestion.

The apparatus may be caused to receive rules with an indication that one of more of the one or more communication devices and/or the network entity can determine to reduce or suspend data duplication.

The apparatus may be caused to determine that the data duplication is to be reduced or suspended based on received rules with an indication that one of more of the one or more communication devices and/or the network entity can determine to reduce or suspend data duplication.

The rules may be received from a control plane entity.

The apparatus may be caused to cause a message to be sent to a respective communication device indicating that data duplication between that communication device and the network entity is to be modified to reduce or suspend the data duplication.

The message may comprise one or more of: information indicating a quantity of the reduction of the data duplication; information as to a duration of the reducing or suspending of the data duplication; and/or information indicating on which of the plurality of paths the data duplication is to be reduced or suspended.

The message may be sent to the respective communication device via the user plane.

The message may comprise information indicating a quantity of the reduction of the data duplication.

The message may comprise information as to a duration of the reducing or suspending of the data duplication.

The message may comprise information indicating on which of the plurality of paths the data duplication is to be reduced or suspended.

The apparatus may be caused to subsequently cause a message to be sent to a respective communication device ending the reducing or suspending the data duplication.

The apparatus may be provided in or by the network entity, said network entity being a user plane function.

The apparatus may be caused to receive from a decision entity information to determine that data duplication between the communication device and the network entity is to be modified to reduce or suspend the data duplication.

The information from the decision making entity may comprise one or more of: network area information associated with data duplication; monitoring information for the monitoring of congestion in the network; and/or traffic duplication modification information.

The apparatus may be caused to report network congestion information to the decision entity.

The apparatus may be provided in or by a decision entity.

According to a fourth aspect there is provided a method comprising: determining that data duplication over a plurality of respective paths between one or more communication devices and a network entity is to be modified to reduce or suspend the data duplication.

The method may comprise determining: for which of the one or communication devices the data duplication is to be reduced or suspended; on which path for a respective communication device the data duplication is to be reduced or suspended; and/or for a respective communication device by how much the data duplication is to be reduced.

The method may comprise determining for which of the one or communication devices the data duplication is to be reduced or suspended.

The method may comprise determining on which path for a respective communication devices the data duplication is to be reduced or suspended.

The method may comprise determining for a respective communication device by how much the data duplication is to be reduced.

The method may comprise determining that the data duplication is to be reduced or suspended in response to network congestion.

The method may comprise determining network congestion.

The method may comprise determining network congestion based on information from one or more communication devices, and/or one or more network entities.

The method may comprise determining network congestion based on information received by a network entity via control plane or user plane connections.

The method may comprise determining an indication of a usefulness of the duplication.

The indication of the usefulness of the duplication may be based on a number of data duplicates which had not previously been successfully received over another path.

The indication of the usefulness of the duplication may be used to determine one or more of: network congestion; and/or that data duplication for a respective communication device is to be reduced or suspended.

The method may comprise determining that the data duplication is to be reduced or suspended may use the indication of the usefulness of the duplication to determine network congestion.

The method may comprise receiving rules with an indication that one of more of the one or more communication devices and/or the network entity can determine to reduce or suspend data duplication.

The method may comprise determining that the data duplication is to be reduced or suspended based on received rules with an indication that one of more of the one or more communication devices and/or the network entity can determine to reduce or suspend data duplication.

The rules may be received from a control plane entity.

The method may comprise causing a message to be sent to a respective communication device indicating that data duplication between that communication device and the network entity is to be modified to reduce or suspend the data duplication.

The message may comprise one or more of: information indicating a quantity of the reduction of the data duplication; information as to a duration of the reducing or suspending of the data duplication; and/or information indicating on which of the plurality of paths the data duplication is to be reduced or suspended.

The message may be sent to the respective communication device via the user plane.

The message may comprise information indicating a quantity of the reduction of the data duplication.

The message may comprise information as to a duration of the reducing or suspending of the data duplication.

The message may comprise information indicating on which of the plurality of paths the data duplication is to be reduced or suspended.

The method may comprise subsequently causing a message to be sent to a respective communication device ending the reducing or suspending the data duplication.

The method may be provided by an apparatus. The apparatus may be provided in or by the network entity, said network entity being a user plane function.

The method may comprise receiving from a decision entity information to determine that data duplication between the communication device and the network entity is to be modified to reduce or suspend the data duplication.

The information from the decision making entity may comprise one or more of: network area information associated with data duplication; monitoring information for the monitoring of congestion in the network; and/or traffic duplication modification information.

The method may comprise reporting network congestion information to the decision entity.

The method may be provided by an apparatus. The apparatus may be provided in or by a decision entity.

According to a fifth aspect, there is provided an apparatus comprising: means for determining that data duplication on one of a plurality of paths between a communication device and a network entity is to be modified to reduce or suspend the data duplication.

The means for determining that determining that the data duplication is to be reduced or suspended may determine that the data duplication is to be reduced or suspended in response to communications device criteria.

The communications device criteria may comprise a battery condition.

The communications device criteria my comprise a network congestion.

The means for determining that determining that the data duplication is to be reduced or suspended may determine that the data duplication is to be reduced or suspended in response to an information received from the network entity.

The apparatus may comprise means for determining an indication of a usefulness of the duplication.

The indication of the usefulness of the duplication may be based on a number of data duplicates which had not previously been successfully received over another path at the communication device.

The apparatus may be provided by or in the communications device.

According to a sixth aspect, there is provided an apparatus comprising: circuitry configured to determine that data duplication on one of a plurality of paths between a communication device and a network entity is to be modified to reduce or suspend the data duplication.

The circuitry configured to determine that the data duplication is to be reduced or suspended may determine that the data duplication is to be reduced or suspended in response to communications device criteria.

The communications device criteria may comprise a battery condition.

The communications device criteria my comprise a network congestion.

The circuitry configured to determine that the data duplication is to be reduced or suspended may determine that the data duplication is to be reduced or suspended in response to an information received from the network entity.

The apparatus may comprise circuitry configured to determine an indication of a usefulness of the duplication.

The indication of the usefulness of the duplication may be based on a number of data duplicates which had not previously been successfully received over another path at the communication device.

The apparatus may be provided by or in the communications device.

According to a seventh aspect, there is provided an apparatus comprising at least one processor and at least one memory storing instructions that, when executed by the at least one processor cause the apparatus at least to: determine that data duplication on one of a plurality of paths between a communication device and a network entity is to be modified to reduce or suspend the data duplication.

The apparatus may be caused to determine that the data duplication is to be reduced or suspended in response to communications device criteria.

The communications device criteria may comprise a battery condition.

The communications device criteria my comprise a network congestion.

The apparatus may be caused to determine that the data duplication is to be reduced or suspended in response to an information received from the network entity.

The apparatus may be caused to determine an indication of a usefulness of the duplication.

The indication of the usefulness of the duplication may be based on a number of data duplicates which had not previously been successfully received over another path at the communication device.

The apparatus may be provided by or in the communications device.

According to an eighth aspect, there is provided a method comprising: determining that data duplication on one of a plurality of paths between a communication device and a network entity is to be modified to reduce or suspend the data duplication.

The method may comprise determining that the data duplication is to be reduced or suspended may determine that the data duplication is to be reduced or suspended in response to communications device criteria.

The communications device criteria may comprise a battery condition.

The communications device criteria my comprise a network congestion.

The method may comprise determining that the data duplication is to be reduced or suspended in response to an information received from the network entity.

The method may comprise determining an indication of a usefulness of the duplication.

The indication of the usefulness of the duplication may be based on a number of data duplicates which had not previously been successfully received over another path at the communication device.

The method may be performed by an apparatus. The apparatus may be provided by or in the communications device.

According to a ninth aspect, there is provided an apparatus comprising: means for determining, that sending of data over a plurality of respective paths between one or more communication devices and a network entity is to be modified to reduce the number of paths over which the data is sent.

It should be appreciated that one or more of the features discussed in relation to the first aspect may be modified to be used in conjunction with this aspect. In particular the data duplication modification discussed in relation to the features of the first aspect would instead be the reducing of the number of paths over which the data is sent.

The means for determining that the sending of data over a plurality of respective paths is to be modified, may determine one or more of: for which of the one or communication devices the sending of data over a plurality of respective paths is to be modified; on which path for a respective communication device the sending of data over a plurality of respective paths is to be modified; and/or for a respective communication device by how much sending of data over a plurality of respective paths is to be modified.

The means for determining that the sending of data over a plurality of respective paths is to be modified, may determine this in response to network congestion.

The apparatus may comprise means for determining network congestion.

The apparatus may comprise means for determining network congestion based on information from one or more communication devices, and/or one or more network entities.

The apparatus may comprise means for determining network congestion based on information received by a network entity via control plane or user plane connections.

The apparatus may comprise means for determining an indication of a usefulness of the sending of data over a plurality of respective paths.

The indication of the usefulness may be based on a number of data packet which are successfully received over a given path.

The indication of the usefulness may be used to determine one or more of: network congestion; and/or that that the sending of data over a plurality of respective paths is to be modified.

The apparatus may comprise means for receiving rules with an indication that one of more of the one or more communication devices and/or the network entity can determine to modify the sending of data over a plurality of respective paths.

The rules may be received from a control plane entity.

The apparatus may comprise means for causing a message to be sent to a respective communication device indicating that that the sending of data over a plurality of respective paths is to be modified.

The message may comprise one or more of: information as to a duration of the modification; and/or information indicating on which of the plurality of paths the data sending is to be modified.

The message may be sent to the respective communication device via the user plane.

The apparatus may be provided in or by the network entity, said network entity being a user plane function.

The apparatus may comprise means for receiving from a decision entity information used by the determining means to determine that data duplication between the communication device and the network entity is to be modified to reduce or suspend the data duplication.

The information from the decision making entity may comprise one or more of: network area information; monitoring information for the monitoring of congestion in the network; and/or information about the modifying of the sending of data over the plurality of respective paths.

The apparatus may comprise means for reporting network congestion information to the decision entity.

This may be used for load balancing.

According to a tenth aspect, there is provided a method comprising: determining, that sending of data over a plurality of respective paths between one or more communication devices and a network entity is to be modified to reduce the number of paths over which the data is sent.

It should be appreciated that one or more of the features discussed in relation to the fourth aspect may be modified to be used in conjunction with this aspect. In particular the data duplication modification discussed in relation to the features of the fourth aspect would instead be the reducing of the number of paths over which the data is sent.

The method may comprise determining one or more of: for which of the one or communication devices the sending of data over a plurality of respective paths is to be modified; on which path for a respective communication device the sending of data over a plurality of respective paths is to be modified; and/or for a respective communication device by how much sending of data over a plurality of respective paths is to be modified.

The method may comprise determining that the data duplication is to be reduced or suspended in response to network congestion.

The method may comprise determining network congestion.

The method may comprise determining network congestion based on information from one or more communication devices, and/or one or more network entities.

The method may comprise determining network congestion based on information received by a network entity via control plane or user plane connections.

The method may comprise determining an indication of a usefulness of the sending of data over a plurality of respective paths.

The indication of the usefulness may be based on a number of data packet which are successfully received over a given path.

The indication of the usefulness may be used to determine one or more of: network congestion; and/or that that the sending of data over a plurality of respective paths is to be modified.

The method may comprise receiving rules with an indication that one of more of the one or more communication devices and/or the network entity can determine to modify the sending of data over a plurality of respective paths.

The rules may be received from a control plane entity.

The method may comprise causing a message to be sent to a respective communication device indicating that that the sending of data over a plurality of respective paths is to be modified.

The message may comprise one or more of: information as to a duration of the modification; and/or information indicating on which of the plurality of paths the data sending is to be modified.

The message may be sent to the respective communication device via the user plane.

The method may be provided by an apparatus. The apparatus may be provided in or by the network entity, said network entity being a user plane function.

The method may comprise receiving from a decision entity information used by the determining means to determine that data duplication between the communication device and the network entity is to be modified to reduce or suspend the data duplication.

The information from the decision making entity may comprise one or more of: network area information; monitoring information for the monitoring of congestion in the network; and/or information about the modifying of the sending of data over the plurality of respective paths.

The method may comprise reporting network congestion information to the decision entity.

This may be used for load balancing.

The method may be performed by an apparatus. The apparatus may be provided by or in the network entity which may be a UPF.

According to an eleventh aspect, there is provided an apparatus comprising: means for determining, that sending of data over a plurality of respective paths between a communication device and a network entity is to be modified to reduce the number of paths over which the data is sent.

It should be appreciated that one or more of the features discussed in relation to the fifth aspect may be modified to be used in conjunction with this aspect. In particular the data duplication modification discussed in relation to the features of the fifth aspect would instead be the reducing of the number of paths over which the data is sent.

The means for determining that the sending of data over a plurality of respective paths is to be modified, may determine this in response to communications device criteria.

The communications device criteria may comprise a battery condition.

The communications device criteria my comprise a network congestion.

The means for determining that the sending of data over a plurality of respective paths is to be modified, may determine this in response to an information received from the network entity.

The apparatus may comprise means for determining an indication of a usefulness of the sending of data over a plurality of respective paths.

The indication of the usefulness may be based on a number of data packet which are successfully received over a given path.

The apparatus may be provided by or in the communications device.

According to a twelfth aspect, there is provided a method comprising: determining, that sending of data over a plurality of respective paths between a communication device and a network entity is to be modified to reduce the number of paths over which the data is sent.

It should be appreciated that one or more of the features discussed in relation to the eighth aspect may be modified to be used in conjunction with this aspect. In particular the data duplication modification discussed in relation to the features of the eighth aspect would instead be the reducing of the number of paths over which the data is sent.

The method may comprise determining that the sending of data over a plurality of respective paths is to be modified, in response to communications device criteria.

The communications device criteria may comprise a battery condition.

The communications device criteria my comprise a network congestion.

The method may comprise determining that the sending of data over a plurality of respective paths is to be modified, may determine this in response to an information received from the network entity.

The method may comprise determining an indication of a usefulness of the sending of data over a plurality of respective paths.

The indication of the usefulness may be based on a number of data packet which are successfully received over a given path.

The method may be performed by an apparatus. The apparatus may be provided by or in the communications device.

The means for determining that the sending of data over a plurality of respective paths is to be modified, may determine one or more of: for which of the one or communication devices the sending of data over a plurality of respective paths is to be modified; on which path for a respective communication device the sending of data over a plurality of respective paths is to be modified; and/or for a respective communication device by how much sending of data over a plurality of respective paths is to be modified.

The means for determining that sending of data over a plurality of respective paths is to be modified, may determine for which of the one or communication devices the data duplication is to be reduced or suspended.

The means for determining that the data duplication is to be reduced or suspended, may determine on which path for a respective communication devices the data duplication is to be reduced or suspended.

The means for determining that the data duplication is to be reduced or suspended, may determine for a respective communication device by how much the data duplication is to be reduced.

The means for determining that the data duplication is to be reduced or suspended, may determine that the data duplication is to be reduced or suspended in response to network congestion.

The apparatus may comprise means for determining network congestion.

The apparatus may comprise means for determining network congestion based on information from one or more communication devices, and/or one or more network entities.

The apparatus may comprise means for determining network congestion based on information received by a network entity via control plane or user plane connections.

The apparatus may comprise means for determining an indication of a usefulness of the duplication.

The indication of the usefulness of the duplication may be based on a number of data duplicates which had not previously been successfully received over another path.

The indication of the usefulness of the duplication may be used to determine one or more of: network congestion; and/or that data duplication for a respective communication device is to be reduced or suspended.

The means for determining that the data duplication is to be reduced or suspended may use the indication of the usefulness of the duplication to determine network congestion.

The means for determining that the data duplication is to be reduced or suspended, may determine that the data duplication for a respective communication device is to be reduced or suspended based on the indication of the usefulness of the duplication.

The apparatus may comprise means for receiving rules with an indication that one of more of the one or more communication devices and/or the network entity can determine to reduce or suspend data duplication

The rules may be received from a control plane entity.

The apparatus may comprise means for causing a message to be sent to a respective communication device indicating that data duplication between that communication device and the network entity is to be modified to reduce or suspend the data duplication.

The message may comprise one or more of: information indicating a quantity of the reduction of the data duplication; information as to a duration of the reducing or suspending of the data duplication; and/or information indicating on which of the plurality of paths the data duplication is to be reduced or suspended.

The message may be sent to the respective communication device via the user plane.

The message may comprise information indicating a quantity of the reduction of the data duplication.

The message may comprise information as to a duration of the reducing or suspending of the data duplication.

The message may comprise information indicating on which of the plurality of paths the data duplication is to be reduced or suspended.

The apparatus may comprise means for subsequently causing a message to be sent to a respective communication device ending the reducing or suspending the data duplication.

The apparatus may be provided in or by the network entity, said network entity being a user plane function.

The apparatus may comprise means for receiving from a decision entity information used by the determining means to determine that data duplication between the communication device and the network entity is to be modified to reduce or suspend the data duplication.

The information from the decision making entity may comprise one or more of: network area information associated with data duplication; monitoring information for the monitoring of congestion in the network; and/or traffic duplication modification information.

The apparatus may comprise means for reporting network congestion information to the decision entity.

According to a further aspect, there is provided a computer program comprising instructions, which when executed by the apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by the apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

3GPP Third generation partnership project
AF Application Function
AMF Access and Mobility Management Function
AUSF Authentication Server Function
ATSSS Access Traffic Steering, Switching and Splitting
CIoT Cellular Internet of things
DCCP Datagram congestion control protocol
DL Downlink
DN Data network
GBR Guaranteed bit rate
gNB gNodeB
GTP GPRS Tunnelling protocol
HPLMN Home PLMN
IoT Internet of Things
IP Internet Protocol
MA PDU Multi access packet data unit
(MP)TCP Multipath transmission control protocol
MS Mobile Station
MTC Machine Type Communication
N3IWF Non-3GPP Inter-Working Function
NEF Network Exposure Function
NF Network Function
NWDAF Network data analytics function
PCF Policy Control Function
PLMN Public Land Mobile Network
PLR Packet Loss Rate
PMF Performance Measurement Function
PMFP PMF Protocol
QoE Quality of experience.
RAM Random Access Memory
(R)AN (Radio) Access Network
ROM Read Only Memory
RTT Round Trip Time
SMF Session Management Function
TA Tracking area
TS Technical Specification
TNGF Trusted Non-3GPP Gateway Function
UL Uplink
UPF User plane function
UDM Unified Data Management
UE User Equipment
5G 5^{th} Generation
5GC 5G Core
5GS 5G System

### BRIEF DESCRIPTION OF THE FIGURES

Some example embodiments will now be described, by way of example only, with reference to the accompanying Figures in which:

FIG. 1 shows a schematic representation of a 5G system;

FIG. 2 shows a schematic representation of an apparatus;

FIG. 3 shows a schematic representation of a user equipment;

FIG. 4 shows a schematic representation of a signal flow to set up a subscription;

FIG. 5 shows a schematic representation of an arrangement in which an external controlling entity connects to a set of UPFs and controls the UPFs to reduce/remove traffic duplication;

FIG. 6 shows a schematic representation in which traffic duplication is being restricted.

FIG. 7 shows a schematic representation in which traffic duplication is being restored or suspended;

FIG. 8 shows a first method of some embodiments;

FIG. 9 shows a second method of some embodiments; and

FIG. 10 shows a schematic representation of a non-volatile memory medium storing instructions which when executed by a processor allow a processor to perform one or more of the steps of any of the methods of FIG. 8 or 9.

### DETAILED DESCRIPTION OF THE FIGURES

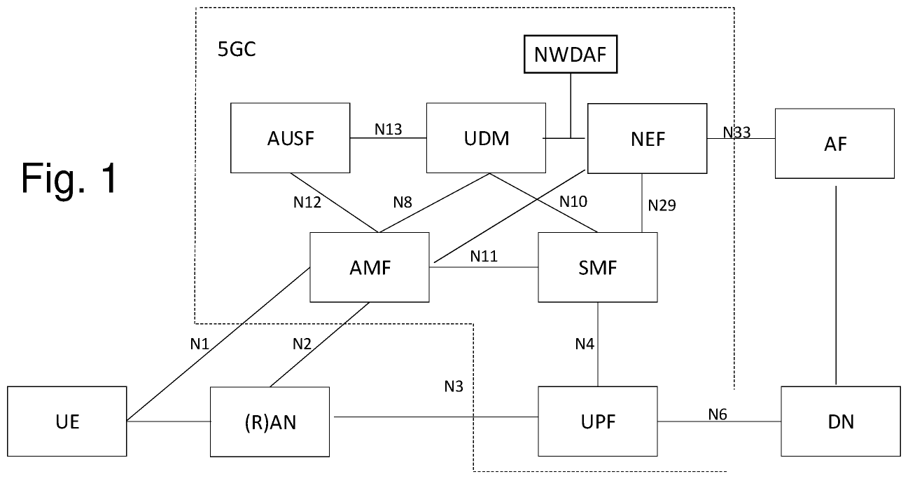

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a user equipment (UE), a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF) a network data analytics function (NWDAF) and/or a network exposure function (NEF).

In some embodiments, one or more network functions may be responsible for providing network analytics information upon request from one or more other network functions or apparatus within the network. Network functions can subscribe to other network functions to receive information therefrom. Accordingly, a network function may be configured to receive and store network information from one or more network functions or apparatus within the network. The data collection by a network may be performed based on at least one subscription to the events provided by at least one other network function.

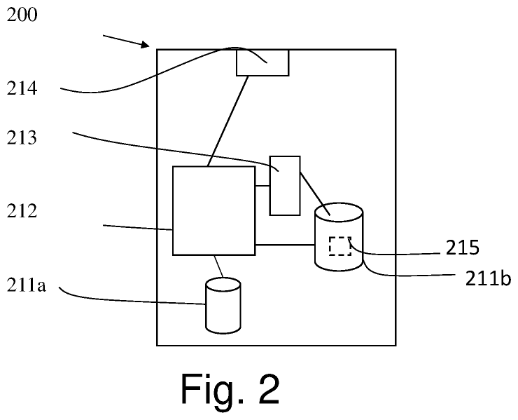

FIG. 2 illustrates an example of an apparatus 200. The apparatus may be provided in a network function. The network function may an intermediate network function, a network function consumer or a network function producer. The apparatus may have at least one processor and at least one memory storing instructions that, when executed by the at least one processor cause one or more functions to be performed. In this example, the apparatus may comprise at least one random access memory (RAM) 211a, and/or at least one read only memory (ROM) 211b, and/or at least one processor 212, 213 and/or an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The apparatus may be provided in one or more network functions.

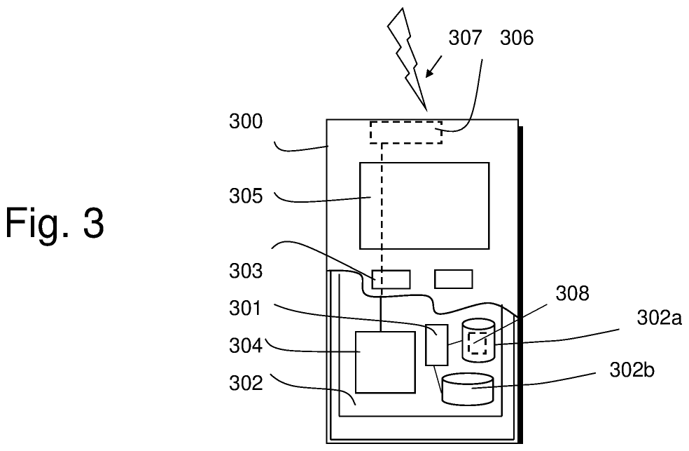

FIG. 3 illustrates an example of a communications device 300, such as the UE illustrated on FIG. 1. The communications device 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The communications device 300 may provide, for example, communication of data for carrying communications. The communications may be one or more of voice, electronic mail (email), text message, multimedia, data, machine data and so on.

The communications device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The communications device 300 may be provided with at least one processor 301, and/or at least one memory ROM 302a, and/or at least one RAM 302b and/or other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304.

The communications device may optionally have a user interface such as keypad 305, touch sensitive screen or pad, combinations thereof or the like. Optionally one or more of a display, a speaker and a microphone may be provided depending on the type of the communications device.

In the following examples, reference is made to a UE as an example of a communications device. It should be noted that this is by way of example only and any other suitable communications device may be used in embodiments.

As part of the 3GGP release 18 work enhancements to ATSSS are considered. ATSSS is a 3GPP-defined mechanism that aims to provide a more efficient use of 3GPP and non-3GPP accesses for specific applications. For example, ATSSS relates to Traffic Steering (i.e., selecting an access network for a new data flow), Traffic Switching (i.e., moving all traffic of an ongoing data flow from one access network to another preserving continuity), and Traffic Splitting (i.e., splitting traffic of a data flow across two access networks). One aspect relates to the support of redundant traffic steering. This may be to enable the transmitter (UE for UL traffic and UPF for DL traffic) to support redundant traffic steering with a duplication criteria. This may be to improve reliability and latency.

In current proposals, an MA PDU session is established. An access is selected as the primary access and a percentage of the packets are duplicated to the other access. Traffic duplication over multiple paths may reduce end-to-end latency and/or packet loss rate. This may lead to better QoE. However, this may be at a cost of utilizing resources over both accesses. This may increase congestion. To reduce duplication overhead, duplication may be applied only when certain criteria are met and may be disabled when the criteria are no longer met.

Whereas activation of duplication may be based on the state of each of the available accesses, i.e., based on RTT and/or PLR measurements on these accesses, the overall network situation may not be considered for traffic duplication. Thus, it may happen that the network is congested with a heavy load and activating traffic duplication may worsen this situation.

In some embodiments, duplication may be suspended and/or restricted whenever it is beneficial for the overall network performance. In some embodiments traffic duplication may be resumed if the network performance allows for it.

Some embodiments may be used with other ATSSS steering modes. For example, in a case of load balancing the network, the UE may steer temporarily all traffic to the access that is currently not congested and may send no or less traffic to the congested access.

Thus, existing proposals on ATSSS with traffic duplication may not consider the optimal use of the available resources. Some embodiments may thus take into account the interplay of load-balancing and duplication.

When the user plane of a 5G/6G network area is becoming congested and traffic duplication steering mode is supported, enabling traffic duplication can further increase the congestion. Whilst the individual UE might expect an improved QoE, the overall QoE for UEs in the congested network area may suffer.

Some embodiments may therefore aim to address this. For example, some embodiments may aim to prevent such cases from occurring or to react rapidly upon congestion detection. In some embodiments, the network may support the suspending and/or restricting of the traffic duplication steering mode operations. This may be for some time and/or to some extent. For example, this may be per user, group of users or all users. This may be in certain parts of the network. For example, this may be for one or more cells and/or one or more tracking areas.

One option may be to allow the SMF (or the PCF) to generate updated ATSSS/N4 rules upon detection of congestion.

As discussed, traffic duplication generates redundant packets over selected accesses (one or more). This may cause a waste of resources which may be undesirable, for example, when the network is under congestion. Congestion may be due to the lack of availability of resources at the RAN and/or due to UPF overload. The issue may be amplified in cases where full duplication is applied. This issue may be arise in the case of GBR traffic.

Currently, duplication is not provided on top of steering modes that aim at throughput maximization, i.e., load-balancing and priority-based. This is because generally duplication could deteriorate throughput as discussed previously. In embodiments, instead of simply considering duplication as not applicable, the side-effects of duplication on throughput is determined by detecting congestion.

In some embodiments, if an indication is received that throughput is deteriorating due to congestion detected at any of the end-points, the UPF and/or UE may reduce/stop duplication.

Some embodiments may provide user-plane and/or control-plane options for i) detecting congestion, and consequently ii) suspend and resume duplication.

Some embodiments provide a duplication steering mode with congestion-based suspension.

In some embodiments, where the control plane has indicated data duplication, the UPF may at runtime override this over the user plane. This overriding by the UPF will be without involvement of the control plane. This overriding may result in the data duplication being reduced or suspended. The overriding by the UPF may take place in response to congestion detection. The UPF may provide an indication to the UE via the user plane, without involving the control plane, that the data duplication is suspended or reduced.

In some embodiments, ATSSS and N4 rules are delivered, for example to the UE and the UPF, respectively. For example, this delivery may be as set out in ATSSS rel-18. The rules may indicate a redundancy steering mode along with an indication that duplication can be suspended and/or reduced by each of the end-points. The endpoint may be the UPF for downlink and the end point may be the UE for the uplink.

For example, the PCF may provide rules to the UPF (via SMF-N4 rules), which give the UPF flexibility to decide if duplication should be applied, based on local link congestion measurements.

Some embodiments may detect congestion.

The entity responsible for detection of congestion may be the UPF. The entity responsible for the detection of congestion may decide whether congestion is ongoing in an area based on one or more of the following:
1) Local measurements at the UPF. These may be PMF measurements and/or (MP)TCP measurements over the user plane and/or QUIC measurements over the user plane and/or DCCP measurements over the user plane.
2) For 3GPP access, measurement assistance by the RAN. For example, the RAN may provide a congestion indication. This may be provided via the N3 interface (e.g., congestion notification in IP or GTP packets) to the UPF. The congestion indication may alternatively be provided by the RAN via the N2 interface to the AMF, which forwards the indication to SMF and SMF forwards the indication to the UPF. In the latter case the RAN indicated congestion is applicable to all UEs served by a certain base station. This information is provided from SMF to UPF.
3) For non-3GPP access, measurements may be provided between the UE and UPF. Alternatively or additionally, the measurements may be provided between the UE and other nodes such as N3IWF and/or TNGF.

Some embodiments may provide congestion mitigation

Once congestion is detected, the UPF selects the suspending of downlink duplication for certain UEs. The UPF may provide a duplication suspend indication to the affected UEs to adjust uplink duplication. The UPF may be assisted by the NWDAF in the providing of congestion mitigation.

The UPF may determine which UEs are affected. The UPF may determine how the UE duplication should be adjusted. In its simplest form, duplication is suspended completely for all the UEs or for a number of UEs. The selection may be implemented in a number of different ways.

The notification is delivered over user-plane via a separate message to each UE via PMF protocol extensions.

The notification may also include an indication on which access the duplication is suspended and for how long.

In an alternative embodiment, the UPF may provide the suspend indication to RAN. This may be via the N3 interface or via the SMF to UPF to N2 interface route. The RAN may broadcast the indication to all UEs in its serving area.

Instead of suspending the duplication, the notification may include a duplication reduction indication, which instructs either the maximum traffic duplication budget that can be maintained (e.g., can duplicate up to 20%) or the reduction in traffic duplication budget (e.g. can reduce duplication by 50%).

The UEs receiving the duplication suspend indication update, adjust accordingly the uplink duplication.

The entity that can best measure the effectiveness or usefulness of duplication is the destination, i.e. the UE for the downlink and the UPF for the uplink. The destination can calculate out of the duplicates received how many were useful, i.e., which duplicates have not been successfully received over the other access. This metric will be referred to as the duplication metric in this document. The duplication metric can be provided over any access to the other endpoint. This duplication metric may indicate the importance of duplication for the specific UE.

This duplication metric may be used in some embodiments for congestion detection, and/or to guide the selection of the UEs for which to suspend or reduce duplication.

This duplication metric is distinct from the packet loss metric which measures packet loss measured for each access at destination, as it also considers whether the duplicate from the other access has been received. For example, if the congestion is at the UPF, the observed PLR on the two accesses will be comparable, and duplication would not be beneficial.

This duplication metric is measured over actual traffic after duplication elimination. This metric may be reported similarly to (or as part of) an availability report or similarly to the per access PLR measurements.

It should be appreciated that in some embodiments, alternatively or additionally the packet loss metric can be used for congestion detection, and/or to guide the selection of the UEs for which to suspend or reduce duplication.

Some embodiments may use the duplication metric as a duplication criterion. For example, duplication will only be implemented if the duplication metric indicates that the duplication usefulness is above a given threshold and if congestion has not been indicated. For example, the duplication can be implemented if usefulness of duplication is >20% or any other suitable value.

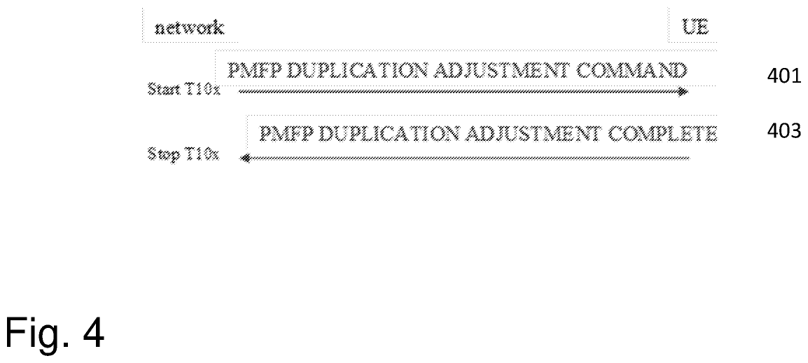

Reference is made to FIG. 4 which shows a signal flow of some embodiments.

This example is focussed on the UPF deciding the duplication and indicating to the UE how to adjust its uplink duplication. However, it should be appreciated that the same technique can be applied in the other direction by the UE, i.e., for indicating to the UPF that the duplication applied at the downlink should be adjusted. This may for example be in the in the case that the UE has low battery and would like to deactivate one access. For example, the UE may want to deactivate its WiFi access.

It is determined by configuration whether it is the UE and/or the UPF that decides the duplication adjustment.

The ATSSS and N4 rules may be provisioned with a redundancy steering mode and optionally, with a steering mode duplication indicator. This indicator may indicate that duplication adjustment upon congestion detection is allowed if the indicator is present. This will indicate that upon congestion detection duplication at either or both of the end-points (UPF for downlink, UE for uplink) can be one or more of:
i) suspended;
ii) reduced to partial duplication of x %; and/or
iii) adjusted at will with the optional indication of a maximum duplication. This may be expressed as a percentage of packets to be duplicated.

This can be implemented similarly to the indication of autonomous load-balance operation, i.e., with a separate indication as part of the ATSSS container or N4 rules container delivered to the UE and the UPF respectively. This is discussed in TS 23.501 and TS 24.193.

Notice that this may be implemented similarly to the UE assistance provided by the UE to the network in UE-assistance operation, with the difference that here it works in the opposite direction, i.e., the network provides the guidance to the UE and that the UE is obliged to follow the provided guidance.

During operation, a UPF that has received the steering mode duplication indicator is responsible for congestion detection by local means or any other info available.

Reference is made to FIG. 4 which shows a message exchange between the network and the UE. Once congestion is detected, the UPF locally selects which UEs to suspend downlink duplication. The UPF provides, via the user-plane, a duplication suspend indication to the affected UEs to adjust the uplink duplication. This is shown in FIG. 4 as referenced 401. This may be via a PMF Protocol duplication adjustment command.

The command may include the adjusted percentage of duplication, if partial duplication is supported, or may leave it up to the UE to decide how much to reduce the duplication.

For full duplication cases, the command may include an indication on which access the duplication is suspended.

Upon receipt, the UE adjusts its uplink duplication as per the received indication which overrides the original duplication provided via the ATSSS rules. The UE will provide an indication that the adjustment has been completed to the UPF. As referenced 403, the UE will send an PMF P duplication adjustment complete response to the UPF Once congestion is resolved, the UPF sends a termination command to the UE.

The PMF protocol may use the duplication metric discussed previously.

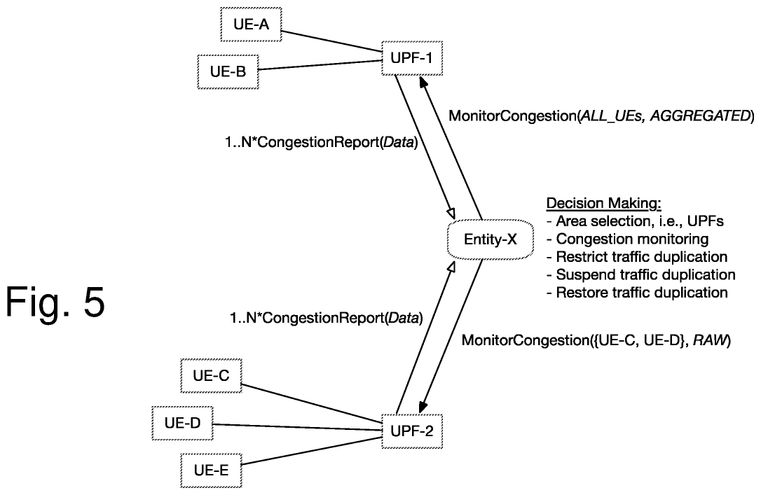

Some embodiments may provide congestion control applied by an external entity over the control plane. In this regard reference is made to FIG. 5 in which an external controlling entity (Entity-X) connects to a set of UPFs (UPF-1 and UPF-2) and controls them by instructing what to do to reduce/remove traffic duplication to ensure that under all load conditions there are enough networking resources available. Entity-X is the logical point where decisions are conveyed towards U-plane counterparts, i.e., UPFs. Entity-X can be any suitable entity such as the PCF, the SMF, any other network NF, or an external AF.

UPF-1 controls UE-A and UE-B in this example and UPF-2 controls UE-C, UE-D and UE-E. In practice, each UPF will control many more UEs than illustrated in this example.

These decisions may comprise one or more of the following:
Area selection. This defines the area to which the decision applies. This may be one or more cells, one or more TA, the whole network and/or any other suitable indication of area
Starting/stopping congestion monitoring. This defines when the congestion monitoring starts and/or ends
Traffic duplication adjustments. This may define if the duplication is to be reduced and if so by how much. This may define if the duplication is to be suspended and/or restarted. This may also include one or more criteria defining when the duplication is to be reduced, suspended and/or restarted. Where the duplication is to be reduced, this may include information as to how much by. There may be one or more criteria associated with the level of duplication which is to be applied.

In some embodiments, Entity-X may have a distributed deployment where each area has dedicated Entity-X, which then directly connects to its local UPFs. In the example of FIG. 5, Entity-X has decided to request UPF-1 and UPF-2 to start congestion monitoring by issuing congestion monitoring requests (MonitorCongestion( )). In those requests, the first parameter is the list of target UEs or ALL_UEs-wildcard. The second parameter indicates how the information is reported back, i.e., as raw data or as already (pre)processed aggregate. In the example of FIG. 5, Entity-X sends a request to the first UPF-1 requesting data for all the of the UEs and in aggregated form. The UPF-1 will provide a congestion report to the Entity-X with the requested aggregated data. In the example of FIG. 5, Entity-X sends a request to the second UPF-2 requesting data for UE-C and UE-Ds and in raw form. The second UPF-2 will provide a congestion report to the Entity-X with the requested raw data.

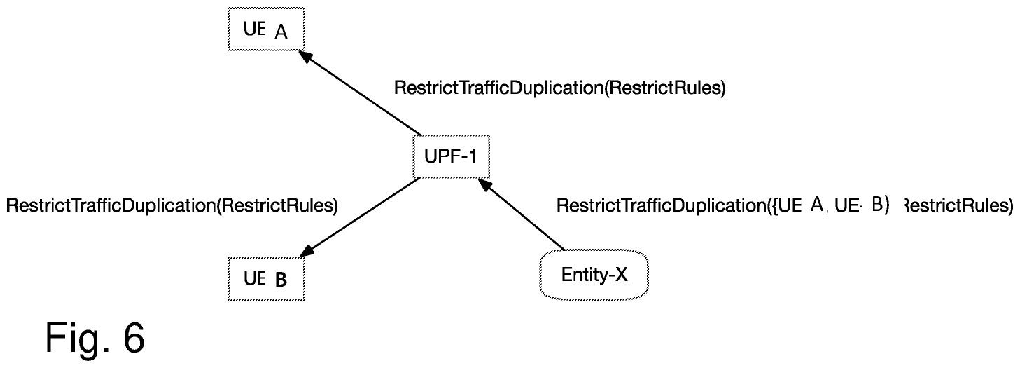

Reference is made to FIG. 6 which shows an example where traffic duplication is being restricted. In this example, the communication between the UPF and the UE may be done on top of QUIC, i.e., requests from the UPF and their replies can be signalled using an in-bound protocol on top of the QUIC session. QUIC is a protocol defined by the Internet Engineering Task Force (IETF) that operates at the transport layer). Alternatively, out-of-bounds signalling can be used to implement that messaging between the UPF and the UE.

As shown in FIG. 6, the Entity-X sends restrict traffic duplication information to the UPF-1. This provides information as to the UEs (UE-A and UE-B in this example) to which this applies and information on how to restrict the extra duplication traffic by adjusting the related traffic duplication budget values and/or relaxing the related traffic duplication conditions. This may be provided by a parameter, RestrictRules-parameter in this example, which carries the information on how to restrict the extra duplication traffic by adjusting the related traffic duplication budget values and/or relaxing the related traffic duplication conditions.

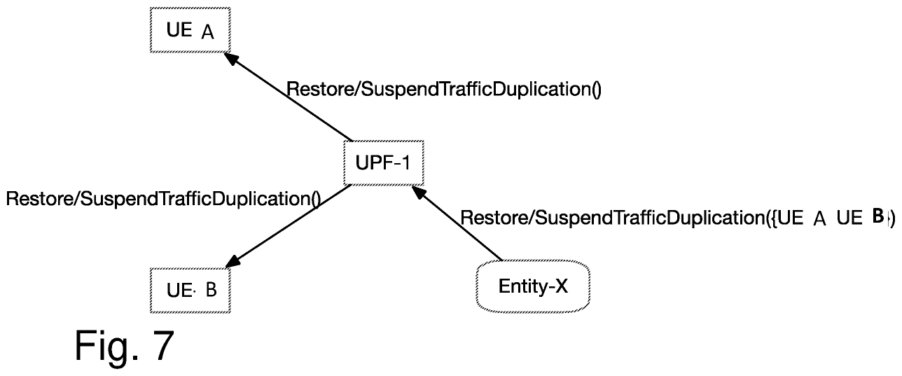

If restricting traffic duplication step did not work, then the traffic duplication operation can be disable until the load conditions are improved. The congestion monitoring operation continues enabled since based on the resulting congestion reports, Entity-X or some other related entity can draw the conclusion that now the current load conditions are such that all temporarily disabled traffic duplication operations can be restored. In this regard, reference is made to FIG. 7 which shows an example where traffic duplication is being restored/suspended.

In this example, the communication between the UPF and the UE may be done on top of QUIC, i.e., requests from the UPF and their replies can be signalled using an in-bound protocol on top of the QUIC session. Alternatively, out-of-bounds signalling can be used to implement that messaging between the UPF and the UE.

As shown in FIG. 7, the Entity-X sends traffic duplication restore/suspend information to the UPF-1. This provides information as to the UEs (UE-A and UE-B in this example) to which this applies and information on if the duplication traffic is restored or suspended. This may be provided by a parameter, Restore/SuspendTrafficDuplication-in this example.

Alternatively, some embodiments may be provided over the control plane. The entity responsible for detecting and indicating congestion may be the NWDAF, or any other suitable control plane network entity, or AF. The control plane entity may collect data from the UPF and exposes the data to PCF. The PCF may update ATSSS rules accordingly. For example, 3GPP enhanced Network Automation features (eNA) have defined “User data congestion analytics” which can be consumed by the PCF which in turn could feed the SMF with updated ATSSS and N4 rules which suspend/reduce duplication.

This out-of-band mechanism may reuse available mechanisms.

It should be appreciated that in the above examples, the UPF is the termination point for the uplink. It should be appreciated that similar decision making can be applied by each UE. If allowed by the network (see autonomous load balancing) either independently decide when to apply duplication based on its internal condition, e.g., battery state, or it may provide a duplication suspend indication to the corresponding UPF.

Some embodiments which are implemented over the user plane may be able to mitigate immediately the potential effects of traffic duplication.

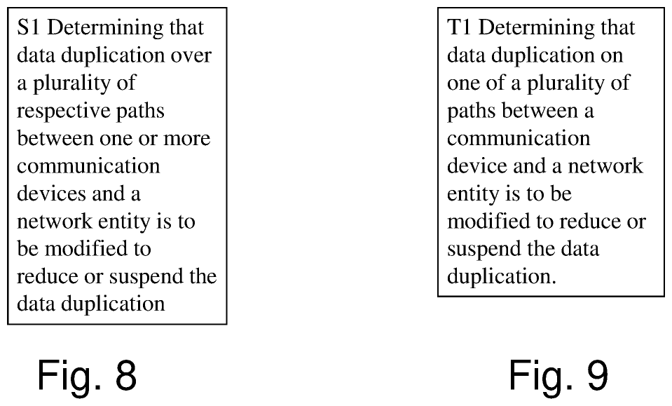

Reference is made to FIG. 8 which shows a first method of some embodiments.

This method may be performed by an apparatus. The apparatus may be in or be a network entity. The network entity may be the UPF or an external entity.

The apparatus may be comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced S1, determining that data duplication over a plurality of respective paths between one or more communication devices and a network entity is to be modified to reduce or suspend the data duplication.

Reference is made to FIG. 9, which shows a second method of some embodiments.

This method may be performed by an apparatus. The apparatus may be in or be a communications device.

The apparatus may be comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2 or 3.

The method may be provided by computer program code or computer executable instructions.

The method may comprise as referenced T1, determining that data duplication on one of a plurality of paths between a communication device and a network entity is to be modified to reduce or suspend the data duplication.

It should be appreciated that the methods outlined in FIG. 8 or 9 may be modified to include any of the previously described features.

Some embodiments propose to enable the UPF to temporarily suspend duplication, if needed, e.g., under congestion.

In ATSSS deployments, full duplication may be used as the basic configuration of redundancy steering mode (RSM). However, full duplication may have the highest cost in terms of network resource utilization, and inevitably increases network congestion. When the user plane is becoming congested, blindly using traffic duplication may further increase network congestion. Thus, though an individual UE would expect improved performance, the collective impact of RSM on the overall network performance may be negative. In embodiments, the network may support suspending/reducing the duplication for some time and to some extent.

The UPF may identify the impact of duplication on the system. Thus, the UPF whenever detects congestion, or when it is considers that duplication is not efficient (e.g., since the same packets are being lost on both accesses due to UPF overload, the same performance would be achievable even without duplication), it may override the RSM configuration and suspend duplication for certain UEs. Especially for cases of full duplication, such an adjustment may rapidly address the congestion issue.

When duplication adjustment operation is authorized by the PCF in the PCC Rule, the SMF provides an indication for duplication adjustment in the ATSSS Rule to the UE, and in the MAR to the UPF.

Once the need for duplication adjustment is identified, the UPF may easily adapt to such a situation by changing by itself the duplication in the downlink. Regarding the uplink, the UE needs to be informed about this necessary adjustment. This can be provided by the UPF via user plane by extending the PMF Protocol with a message. The message may be implemented similarly to the UE assistance provided by the UE to the network in UE-assistance operation, with the difference that the network provides the guidance to the UE and that the UE is obliged to follow the provided guidance.

The UPF may fully suspend duplication or may indicate the percentage of partial duplication as the necessary adjustment.

Once the congestion issue is resolved, the UPF may terminate the duplication adjustment operation with a PMF protocol termination message.

The same result may be achieved by updating the ATSSS/N4 rules.

The ATSSS rules and the N4 rules are enhanced in some embodiments, with a new steering mode definition and with new parameters, including the support of traffic duplication suspension.

Based on the PCC rules, the SMF may create ATSSS rules and N4 rules with the new steering mode data including optional traffic duplication criteria, and an indication that the UE/UPF is allowed to suspend duplication, if needed.

The PCF may provide PCC rules considering the new steering mode including optional traffic duplication criteria to the SMF, and an indication that the UE/UPF is allowed to suspend duplication, if needed.

The UPF, based on the traffic duplication steering mode and optionally available traffic duplication criteria, may decide when to duplicate traffic via the available access paths of a MA PDU session for the downlink traffic. If an indication that the UPF is allowed to suspend duplication has been received, it can adjust its duplication at will and indicate any updates to a UE to apply the same for the uplink.

Based on the traffic duplication steering mode and optionally available traffic duplication criteria, the UE may decide when to duplicate traffic via the available access paths of a MA PDU session for the uplink traffic. If an indication that the UPF is allowed to suspend duplication has been received, upon receipt from the UPF of duplication updates, the UE applies UPF duplication guidance on the uplink, e.g., suspending duplication.

The described embodiments have been in the example context of data duplication where a data packet is sent over two paths between a network entity and the communications device. The same principles may be used with any other scenario where two or more paths are available between a communications device and the network entity. For example, these principles may be applied to provide load balancing where the paths which are used between the communications device and the network may be controlled by the UPF or other user plane entity.

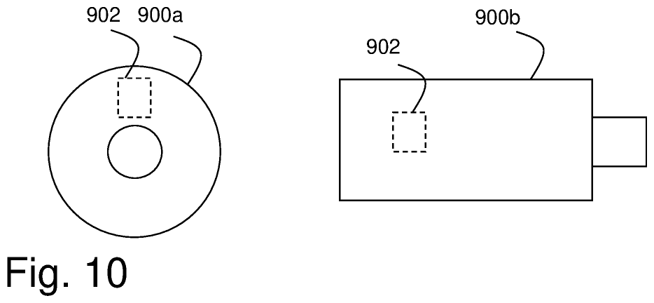

FIG. 10 shows a schematic representation of non-volatile memory media 900a or 900b storing instructions and/or parameters which when executed by a processor allow the processor to perform one or more of the steps of the methods of FIG. 8 or 9. The non-volatile memory media may be a computer disc (CD), or digital versatile disc (DVD) schematically referenced 900a or a universal serial bus (USB) memory stick schematically referenced 900b. The computer instructions or code may be downloaded and stored in one or more memories. The memory media may store instructions and/or parameters 902 which when executed by a processor allow the processor to perform one or more of the steps of the methods of FIG. 8 or 9.

Computer program code may be downloaded and stored in one or more memories of the device.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 8 or 9, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Alternatively, or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (I) a combination of analogue and/or digital hardware circuit(s) with software/firmware and
   (ii) any portions of hardware processor(s) with software (including digital signal processor(s)), software, and memory(is) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory storing instructions for a user plane function, wherein the instructions when executed by the at least one processor cause the apparatus to perform at least:
determining that data duplication over a plurality of respective paths between one or more communication devices and a network entity is to be modified to suspend the data duplication; and
sending a message to respective communication devices of the one or more communication devices, the message comprising an indication that data duplication between the respective communication device and the network entity is to be modified to suspend the data duplication.

2. The apparatus as claimed in claim 1, wherein the determining that the data duplication is to be suspended comprises determining at least one of:
for which of the one or communication devices the data duplication is to be reduced or suspended;
on which path for a respective communication device the data duplication is to be reduced or suspended; or
for a respective communication device by how much the data duplication is to be reduced.

3. The apparatus as claimed in claim 1, wherein the determining that the data duplication is to be suspended comprises determining that the data duplication is to be suspended in response to determining there is network congestion.

4. The apparatus as claimed in claim 3, wherein determining there is network congestion is based on information received from one or more communication devices, or one or more network entities.

5. The apparatus as claimed in claim 3, wherein determining there is network congestion is based on information received by a network entity via control plane or user plane connections.

6. The apparatus as claimed in claim 1, wherein the instructions, when executed by the at least one processor, further cause the apparatus to perform: determining an indication of a usefulness of the data duplication.

7. The apparatus as claimed in claim 6, wherein the indication of the usefulness of the data duplication is based on a number of data duplicates which had not previously been successfully received over another path.

8. The apparatus as claimed in claim 7, wherein the indication of the usefulness of the data duplication is used to determine at least one of: network congestion; or that data duplication for a respective communication device is to be suspended.

9. The apparatus as claimed in claim 1, the instructions, when executed by the at least one processor, further cause the apparatus to perform: receiving rules with an indication that one of more of the one or more communication devices and/or the network entity can determine to suspend data duplication

10. The apparatus as claimed in claim 1, wherein the message comprises at least one of:
information as to a duration of the suspending of the data duplication; or
information indicating on which of the plurality of paths the data duplication is to be suspended.

11. The apparatus as claimed in claim 10, wherein the message is sent to the respective communication device via a user plane.

12. The apparatus as claimed in claim 1, wherein the instructions, when executed by the at least one processor, further cause the apparatus to perform: subsequently sensing a message to the respective communication devices ending the suspending the data duplication.

13. The apparatus as claimed in claim 1, wherein the instructions, when executed by the at least one processor, further cause the apparatus to perform: receiving, from a decision entity, information and wherein the determining that data duplication between the communication device and the network entity is to be modified to suspend the data duplication is further based on the information.

15. The apparatus as claimed in claim 14, wherein the information received from the decision making entity comprises at least one of: network area information associated with data duplication; monitoring information for the monitoring of congestion in the network; or traffic duplication modification information.

16-21. (canceled)

22. A method comprising:
determining, by a user plane function, that data duplication over a plurality of respective paths between one or more communication devices and a network entity is to be modified to suspend the data duplication; and
sending, by the user plane function, a message to respective communication devices of the one or more communication devices, the message comprising an indication that data duplication between the respective communication device and the network entity is to be modified to suspend the data duplication.

23. The method as claimed in claim 22, wherein the determining, by a user plane function, that the data duplication is to be suspended comprises determining at least one of:
for which of the one or communication devices the data duplication is to be reduced or suspended;
on which path for a respective communication device the data duplication is to be reduced or suspended; or
for a respective communication device by how much the data duplication is to be reduced.

24. The method as claimed in claim 22, wherein the determining that the data duplication is to be suspended comprises determining that the data duplication is to be suspended in response to determining there is network congestion.

25. The method as claimed in claim 24, wherein determining there is network congestion is based on information received from one or more communication devices, or one or more network entities.

26. The method as claimed in claim 25, wherein determining there is network congestion is based on information received by a network entity via control plane or user plane connections.

27-45. (canceled)
